(19) United States
(12) Patent Application Publication
(10) Pub. No.: US 2008/0007022 A1
(43) Pub. Date: Jan. 10, 2008

(54) Suspension Apparatus

(76) Inventor: Mark De Cooper Jones, Redditch (GB)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/597,682

(22) PCT Filed: May 20, 2005
(86) PCT No.: PCT/GB05/01954

§ 371 Date: Aug. 15, 2007

(30) Foreign Application Priority Data
May 21, 2004 (GB) 0411376.7

(51) Int. Cl. B60G 7/00; B60G 17/027

(52) U.S. Cl. 280/124.13

(57) ABSTRACT

An apparatus for connecting a load to a support comprises a flexible suspension arm of unitary construction and restoring means, the suspension arm being so constructed and arranged to define at least two spaced apart members whose relative location determines the volume of a space which contains the restoring means, deflection of the flexible suspension arm in use causing the arm to deform to alter the relative position of the two spaced apart members, thereby altering the volume of the space and so compressing the restoring means. The apparatus is especially suited to suspension assemblies for vehicles.

### CROSS-REFERENCE TO RELATED APPLICATIONS

This application is a national stage of International Application No. PCT/GB2005/001954 filed May 20, 2005, the disclosures of which are incorporated herein by reference in entirety; and which claimed priority to Great Britain Patent Application No. 0411376.7 filed May 21, 2004, the disclosures of which are incorporated herein by reference in entirety.

### BACKGROUND OF THE INVENTION

This invention relates to an improved suspension apparatus for suspending a load from a support, and in particular, but not exclusively, to a suspension arm. It is envisaged that it will have application within the suspension system of a vehicle. In a further aspect it relates to a method and apparatus for controlling the ride characteristics of a two-wheeled vehicle, especially but not exclusively for use as part of a vehicle control system for a two-wheeled vehicle.

Many applications exist in which it is important to provide a member between a load and a support which is intended to control movement between the load and the support in a predefined manner. Perhaps the most common application is in the suspension system of a vehicle. Conventional suspension systems for connecting a load to a support, e.g. for passenger cars, employ multi-link systems to provide the vertical movement required to achieve vehicle stability through the absorbing of road irregularities. Typically, separate springs and dampers control these responses and give the required chassis response for the vehicle. The main structural components of this conventional suspension would typically be manufactured from steel, with compound, (metal, plastic, rubber) bearings and bushes to fix the elements of the suspension system together and to the vehicle chassis, in order to support it's weight. A further requirement is for the suspension system to locate and support the wheel, hub, stub-axle, and braking assembly (typically a collete type disc unit), as the connection to the road surface.

At the front of the vehicle the steering mechanism must be accommodated, and typically the drive train system too, if a front or 4WD vehicle. Similarly, drive to rear and 4WD vehicles will be required for the rear of the vehicle. Refinement of suspension/chassis response in the ‘passive’ suspension system described above is typically achieved by addition of ‘anti-roll’ bars to the front and rear suspension assembly. Primarily, these link the right and left hand side suspension units on the same axle, in order to limit the differential movement, and hence the vehicle roll that occurs during vehicle cornering. This is shown in FIG. 1, a typical rear suspension assembly 1 of the trailing arm type for a wheel 2 of a passenger car (left hand side rear suspension and truncated chassis shown attached). This also requires bushings and fixings to co-ordinate with the suspension assemblies and connect to the chassis (where required). This incurs more weight, since these parts are also typically manufactured from steel, for reasons of cost, performance and durability. Springing is conventionally by coil or leaf unit in steel.

The resulting suspension assemblies are consequently complex, heavy, prone to corrosion, wear in the moving parts, and present significant technical and cost challenges in development of active suspension capabilities, such as anti-roll, anti-dive and active ride control. This is of increasing importance for active vehicle safety, and in supporting the ongoing improvements being pursued in vehicle ride and handling. Ultimately this requires suspension ‘adaptivity’ that occurs in ‘real time’ on the vehicle to control it's behaviour in use.

### BRIEF SUMMARY OF THE INVENTION

According to a first aspect the invention provides an apparatus for connecting a load to a support which comprises a flexible suspension arm of unitary construction and restoring means, the suspension arm being so constructed and arranged to define at least two spaced apart members whose relative location determines the volume of a space which contains the restoring means, deflection of the flexible suspension arm in use causing the arm to deform to alter the relative position of the two spaced apart members, thereby altering the volume of the space and so compressing the restoring means.

The provision of a suspension arm of unitary construction which acts upon a restoring means under deformation as it is loaded provides a considerable reduction in the number of parts which make up the support. This increases its reliability and the cost of assembly by rationalizing the functions of each part of a suspension assembly into one principal suspension component with no moving parts which can be attached directly to a chassis by the minimum number of effective fixings (e.g. bolts and rubber bushes) e.g. two. The deflection of the unitary construction arm which compresses the restoring means can provide the equivalent operations of a spring-damper of a conventional suspension, but is primarily suited to providing a variable rate spring.

The restoring means may comprise a medium such as a gas or solid or foam which is contained at least partially, and preferably wholly, within the space and which is compressed as the volume of the space decreases, thus contributing to the spring rate of the assembly.

The assembly may be so constructed and arranged that the choice of material and pressure of the restoring means within the space has a significant effect on the spring rate of the assembly. For example, where the restoring medium is a gas confined under pressure within the space, changing the pressure of the gas within the space in an arm may allow the spring rate of the arm to be altered in a fully variable manner by at least 10 percent, or 50 percent or perhaps up to 100 percent, or more.

The flexible arm may be in the manner of a cantilever arm, perhaps a leaf spring type arm, and may have a first fixing region generally arranged to be secured either directly or indirectly to one of a load or a support and a second fixing region generally arranged to be secured directly or indirectly to the other of the load or the support, the arm further including a first arm member which extends from the first fixing region to the second fixing region, a second arm member which also extends from the first fixing region towards the second fixing region, and a connecting member which connects the second arm member to the first fixing region of the arm, the connecting member defining the two spaced apart members, which most preferably comprise wall portions which define parts of a wall defining the closed volume for the damping medium.

The unitary member, and in particular the first and second arm members and the connecting member may generally define a quarter elliptic type spring. In this arrangement the first and second fixing regions may be at generally opposing ends of the arm, with the connecting member preferably being at the end connected to the support. In the case of a vehicle this would mean that the connecting member is at the end connected to the sprung mass (the vehicle chassis).

The first arm member may provide a major spring member which forms the major path for loads from the second region to the first region, in particular torsional loads. The second arm member may function predominantly as a minor spring member. These may be generally elongate, planar members. The first arm member may terminate at a root which is adapted to be secured to a load or support, and the connecting member may be provided between the root and the second arm member. Indeed the root may define a part of the connecting member, typically one wall of the closed space.

In a modification, a component of unitary construction which includes two arms extending from a central fixing region, with one connecting region for each arm, may be provided so as to define a semi-elliptic type spring assembly.

The connecting member may be generally C-shaped or U-shaped with one end of the U or C connected to the second arm member and the other to the first arm member, application of a load to deform the unitary structure pushing the ends of the U or C shape together to reduce the volume the U or C shape encompasses.

The restoring means may be contained within a bladder or bag or other such flexible container which is located in the closed space between the two spaced apart members of the arm, for example within the space enclosed by a U or C shaped connecting member. A closure member or shroud may be provided which co-operates with the spaced apart members of the connecting member to substantially completely close off the space between the spaced apart members, thereby defining a controlled volume whose volume changes as the arm is deflected under load. The volume of the bladder changes because it is in effect trapped within the structure of the arm member and the shroud.

A valve may be provided for the controlled addition or removal of medium from the control space and/or the bladder within the space. This may be connected to a pressurised source of medium which may control the pressure of the damping medium in the control space. Altering the pressure allows the resistance to compression of the medium to be altered, changing the spring rate of the assembly. The valve, or a supply path to the valve or a part of the bladder, may pass through an opening in a part of the unitary member.

The provision of the valve can, in at least some arrangements, provide a further advantage by facilitating direct implementation of active suspension concepts through providing variable stiffness and variable damping within the suspension assembly. Clearly, this can in principle be applied to all wheeled vehicles, and to any structure requiring real time or just variable stiffness, variable deflection/position and variable damping.

Therefore, a controller may be provided together with the assembly for controlling the pressure of the restoring means in the control space. The controller may receive signals from one or more sensors which measure the strains within and/or deflection of one or more parts of the arm. Other information from different sensors may also be processed by the controller depending upon the application. For example, in an automotive application the controller may receive signals indicative of: the rate of deceleration of the vehicle, the speed of the vehicle, yaw rate, steering angle etc.

A remote reservoir may be provided which receives medium expelled from the closed space as the arm bends under load. The reservoir may comprise part of a piston which may be arranged to provide damping and/or hysteresis to the system.

One or more strain gauges may be provided for measuring the stress within parts of the arm, perhaps resistance type gauges bonded to the arm or a part fixed to the arm.

The arm may comprise a fibre reinforced composite (FRC) laminated structure. For example it may be made from a composite material in which fibres are woven or laid up to provide defined strength characteristics and impregnated with a binding material such as a resin which is subsequently cured. A suitable fibre is carbon fibre. The skilled man will appreciate how to prepare a composite structure from such materials once provided with the shape required and the stress characteristics at each point.

Providing the arm as a unitary composite structure offers many potential advantages (although not all embodiments of the invention need to embody all, or indeed any of the following):
Light weight, through high specific mechanical properties; low density & high stiffness/strength.
High deflections coupled with high fatigue strain (versus metals) Carbon Fibre Reinforced Epoxy (CFRE) can approach 1% strain with an infinite fatigue life, due to exceptional elastic properties resulting from the fibre-resin micro-mechanics of FRC materials.
The geometric design of the spring structure combines with the material employed to achieve an inherent level of spring response, sufficient to satisfy the baseline spring requirements of the vehicle; provides fail safe capability should the active suspension element become compromised.
Tunable structural response; a balance of bend and torsion stiffness can be provided in this application and is readily achievable with FRC due to the almost infinitely variable options available for the laminate construction, materials employed and material lay up.
Potential for low cost in high volumes through continuous manufacturing processes e.g. pultrusion; the profile of the part has been designed to be uniform along it's length, such that by this process a continuous length of solid cured material is ejected from the pultrusion die of the cross section matching the silhouette of the FRC element of the arm. Virtually all plastic moulding techniques can also be employed for manufacture of this element, but pultrusion offers the lowest cost. The arm FRC component required is then cut to the width required from the length of pultruded material. Clearly the width of material removed dictates the stiffness and load bearing capability, such that a single pultruded FRC profile can produce components suitable for a wide range of suspension duties and hence applications, i.e., the wider the section cut off the stiffer it will be. In this way a virtual continuous manufacturing capability suitable for high manufacturing volumes is achieved. More complex geometries can be manufactured by techniques such as Resin Transfer Moulding (RTM), and variants thereof.
The FRC Arm can be profiled along it's length after manufacture by local machining, i.e. for variable width, as a further means of manipulating and optimising it's stiffness response.
Metal, rubber type (flexible), or compound bushes for interface of the composite part to the metallic components on the vehicle and system interfaces, e.g. brake caliper mount, stub axle location; these can be moulded directly into the composite part during the manufacturing process, since low pressures and temperatures are typically required, e.g., 1 MPa & 125° C.
Benign failure mode; typically with composite structures a progressive loss of stiffness occurs due to degeneration of the component, before catastrophic loss of strength occurs. This is due to the different failure mechanics of composite materials to metals. These modes can be designed in at the laminate and structural level, to enhance these behaviours.
Condition monitoring; can be incorporated as part of the strain sensing required to give the active response—warning of system problems can be indicated to the operator and system behaviour adapted to compensate, in order to improve resistance to in service damage.

Typically these sensors would be bonded to the outer skin of the composite. However, these potentially sensitive, fragile sensors can be moulded directly into the structure during manufacture due to the relatively low temperatures and pressures occurring—not possible with metals. This reduces system cost.

It is most preferred that the arm has a constant cross section across at least one axis, preferably an axis that is orthogonal to a line between the first and second fixing regions. This can be achieved by providing first and second arm members which are generally planar. Giving it a constant cross section, and in particular one having no undercuts, makes manufacture easier and less costly. Several arms can be formed by cutting slices from a single continuous moulding, e.g. by pultrusion, and no major finishing operations are then needed.

To improve the performance of the arm there may be provided one or more interconnecting struts or webs which connect the first and second members at points in between the first and second regions. These are each preferably of a z-shaped cross section when the arm is unloaded, the top and bottom parts of the Z anchoring the struts to the first and second members.

Again it is preferred that the struts form an integral part of the unitary construction of the member, although they could be separate parts which are glued in place during assembly.

One or more additional links may be provided which connect the second fixing region (the load) to the first fixing region (the support). For example where the arm forms a part of a vehicle suspension system, and where higher duty is required, combined with improved control of wheel camber under suspension deflections, a stabiliser bar can be added. This can be manufactured in a composite material, and is connected directly to the second fixing region, e.g., at the rear, similarly without the use of any moving parts. Similar to the arm, the additional link relies on deflection entirely within the component to achieve the suspension movement required. This results in a limited increase in the suspension deflection stiffness and a significant increase in the torsional stiffness of the arm, such that camber rotation of the wheel under suspension deflection is controlled. The side deflection stiffness is also increased.

Where higher duty again is required with this trailing arm implementation, supplementary torsion control links can be added to fully control the camber of the wheels under deflection of the arm. These would typically be a pair of top & bottom radius arms, employed in the normal manner with conventional multi-link suspension systems. These could also be manufactured in composite, but would require appropriate bushes for attachment to the stub axle carrier on the Smart Arm with rotation capability (as opposed to being rigidly fixed in the light duty case described earlier), similar to conventional suspension practice. This allows vertical de-coupling of the stub axle-arm vertical movement from the radius arms, with the radius arms free to rotate relative to this and the chassis mounting bushes at the other end. The arm can then deflect as required for vertical suspension movement, with the radius arms free to control the rotation of the stub axle from the vertical and hence control the camber of the wheel, as is normal practice on such multi-link suspension systems. Significant weight, simplicity, space and cost advantages would still accrue over a conventional suspension assembly, with the existing advantage of active capacity retained where required.

In an alternative or additional arrangement, a reinforcing sleeve may be provided around at least part of, or completely around, the arm. The sleeve may be fixed to the arm at each end, and may be fixed at least at one end in such a way that the arm can move longitudinally relative to the sleeve to accommodate its change in length as the arm bends. It should, nevertheless, restrain the arm from moving twisting, so providing a support function. This can be achieved through the use of one or more suitably designed coupling bushes, or providing a connection which can slide along a groove to provide for some lost motion.

The sleeve may be pivotally connected to the arm at one end through a connecting bolt which also serves to connect the arm to the member it supports. It may be connected to the arm at the other end through a lost motion connection.

A soft spacer which functions as a bump stop may be provided between the arm and the sleeve, or the sleeve and the member to which the arm is attached, to stop the sleeve hitting the arm or member when the sleeve rotates about its pivot due to deformation of the arm.

The reinforcing sleeve may be of aluminium material, and may be substantially in the form of a U or C-shaped channel which accommodates the arm. It may have a shape which complements the shape of the arm so as to minimise any increase in bulk that it may otherwise cause.

It is appreciated that in some applications it may be undesirable to connect a load directly to the arm. To do so may require appropriate holes to be formed in the arm to receive fasteners for the load such as bolts. These holes may act as stress raisers, reducing the strength of the structure. This problem may be overcome by providing a fixing which encloses at least part of the arm in the region of the second portion and to which the load can be attached. The shroud could be a metal component or several components.

Of course, it should be understood that there need not be a single enclosed volume which contains the damping medium. Indeed, a number of separate or interconnected spaces may be defined which may be filled with damping medium. The volume of one or more of theses spaces may alter as the arm is deformed under load.

The assembly may have many applications. An especially advantageous application for the assembly is within a suspension system for a vehicle.

Therefore, according to a second aspect the invention provides a suspension system which includes at least one support apparatus according to the first aspect of the invention.

According to a third aspect the invention provides a suspension assembly for a vehicle which comprises a fibre reinforced composite arm which defines a space which contains a restoring means, the member being so constructed and arranged that, in use, as the arm bends under loading the volume of the space varies which compresses the restoring means.

The suspension assembly of either the second or the third aspects may include two or more support arms connecting a load to a support, i.e. a wheel to a chassis. These may be arranged such that they are operated in tandem as the forces acting on the arm vary.

Where necessary, a dual arrangement acting as a single unit can be employed with arms attached above & below the load connecting point respectively, i.e. stacked one above the other. The pressure of the restoring means in the space of each arm can be varied to alter the relative position of the load connecting point relative to the support of dual arm arrangement at rest as well as to alter the spring rate of the arrangement. For example, in an automotive application this can be used to alter the ride height of the vehicle and also the spring rate. Increasing the pressure of the restoring medium in the lower arm of such an arrangement whilst decreasing that of the upper may lower the ride height without altering the spring rate, and vice versa.

The suspension assembly may be provided by combining a convention linkage arrangement (such as a trailing arm or multi-link assembly) together with one or more suspension arms according to the first aspect of the invention. In such a case the linkage controls the movement of the wheel and the arm provides the desired springing (or at least part of the required springing). For example, a single arm can be mounted rigidly to a chassis of a vehicle on either side to act upon each of a pair of conventional trailing arms to affect the response required. Also, a single linkage can be mounted at the centreline of the vehicle, similar to a conventional anti-roll bar, serving both sides of the vehicle, with the wheels supported by arms according to the first aspect arranged as trailing arms. In this arrangement the conventional link helps to control the camber of the wheel during arm deflection. However this does produce a degree of coupling between left hand side and right hand side arms. This may be an acceptable situation with regards to the lower mass and ease of installation offered over the separate dual units described. Alternatively, a similar separate camber control link can be attached to each arm.

An advantage of providing two in tandem is that the loading is shared between the conventional spring arms and the arms of the first aspect of the invention.

The two may be placed in series or in parallel. In a series arrangement the arms of each assembly may be aligned side by side with the load acting through an axis common to both arms. This allows the two to share the torsional loads provided by the load. In a parallel arrangement they maybe placed one above the other. In each case, they may be arranged such that the spring rate of each assembly can be varied independently from the other.

The suspension system may include a control means arranged to alter the spring rate of the suspension assembly (or assemblies) to control the vehicle ride height. This may be user definable, for example to provide added clearance when negotiating obstacles, or be automatically controlled. For example, a measurement of load on the suspension when the vehicle is stationary could permit the suspension to self level, or perhaps a measurement of speed could be used to lower the vehicle at increased speeds to improve stability. This is achieved by having two arms (how so ever disposed) operating in opposition to each other.

According to a fourth aspect the invention provides a suspension system for a two wheel vehicle comprising first and second suspension assemblies having adjustable spring rates, each provided on an opposing side of a wheel from the other to support the wheel relative to the frame of the vehicle and permit deflection of the wheel relative to the frame, the system being arranged such that in use the spring rate of each assembly is varied under control of at least one control unit to alter the camber of the wheel relative to the chassis.

By providing two suspension arms, one either side of a wheel, and also providing separate control of their spring rates under the control of a control unit. The camber of the wheel can be varied. This will affect the ride and handling characteristics of the vehicle. The control unit may make changes to the spring rates in real time during use of the vehicle, perhaps whenever the ignition to the vehicle is switched on or only when the vehicle is travelling.

The supports may comprise suspension arms in accordance with the first aspect of the invention. A single forked component of unitary construction, split into two parts to define define two arms of the fork, is preferred.

The control unit may be adapted to vary the spring rates of each suspension assembly in response to signals collected from sensors fixed to the vehicle. These may include yaw rate sensors, lateral accelerometers and/or signals from ABS sensors fitted to the vehicle.

The control system may be arranged to alter the spring rates to compensate for understeer an/or oversteer of the vehicle by applying rear-wheel steer (through camber changes) to increase or decrease the turn angle. This may be performed actively, in real time, independent of the any action taken by the rider to help them steer around a corner.

The control system may be arranged to vary the spring rate of one suspension assembly independently from the other, or they may be dependent on one another. For example, as one increases the other may be made to decrease by a corresponding amount and vice versa.

The control system may be adapted to determine the intended radius of turn of a rider and compare it to the actual radius defined from sensor outputs, and from the difference determine the spring rates to be applied to each suspension assembly to alter the radius of turn of the bike.

The intended radius of turn predicted/planned by the rider can be inferred by the control system from the following outputs from sensors associated with the bike:
the value of the lean angle
mass of vehicle and payload+rider (as indicated by the at rest strain values from the Smart Arm)
angle of rotation of the steering head around the axis of the steering column of the motorcycle (steering angle)

The actual radius of turn may be predicted by the control system ECU with suitable algorithms embedded describing the chassis behaviour of the particular vehicle to which the system is applied. This value may be determined with reference to:
accelerometers to give yaw response for the chassis
accelerometers to give rate of turn for the chassis
angle of lean of the motorcycle

These intended and actual bend radius values may then be compared within the ECU and a corrective amount of rear wheel steer, through rear wheel camber change is applied. This control strategy could be employed to counter under-steer and over-steer cases. This would result in improved safety for the rider and vehicle, by increasing the margins of cornering capability for the vehicle.

Other advantages of this invention will become apparent to those skilled in the art from the following detailed description of the preferred embodiments, when read in light of the accompanying drawings.

### BRIEF DESCRIPTION OF THE DRAWINGS

FIG. 1 illustrates a typical prior art suspension system as fitted to the rear wheel of typically a four wheel road-vehicle;

FIG. 2 is a view similar to that of FIG. 1 in which an embodiment of a suspension assembly in accordance with one aspect of the invention is fitted to a road wheel of a vehicle in an equivalent manner to FIG. 1;

FIG. 3 is an enlarged isometric view of the suspension assembly shown in FIG. 2 (wheel and brake assembly not shown for clarity);

FIG. 4A is a cut-away view of the complete suspension assembly of FIG. 3, cut along a longitudinal cross-section;

FIG. 4B is a similar cut-away view of the end of the suspension assembly that is fixed to the vehicle chassis to show in more detail the location of a restoring means which is at least partially enclosed by the suspension arm;

FIG. 5 is an alternative view of the complete suspension assembly of FIGS. 2 to 4 which itemises all of the relevant components of the suspension assembly;

FIG. 6 is a view of the unified arm member of the assembly in cross section showing the main elements of the unitary component;

FIG. 7 is a still further alternative view which shows the deformation mode of the arm when a load is applied to it;

FIGS. 8 illustrates an alternative embodiment of a suspension assembly in accordance with an aspect of the invention applied to a vehicle in a transverse leaf spring equivalent configuration;

FIGS. 9A and 9B are isometric views from the left and the right of an alternative embodiment of a suspension system in accordance with an aspect of the present invention as fitted to the rear wheel of a two wheeled vehicle;

FIG. 10 is an isometric view of a still further alternative arrangement of a suspension system in accordance with the present invention in which a dual spring assembly is provided with the arms stacked to support a wheel with a ride height compensation facility; and

FIGS. 11A and 11B illustrate a yet further embodiment of a suspension system in accordance with the present invention in which a dual spring assembly is provided with two arms side by side to support a wheel of a vehicle.

FIG. 12 is an alternative embodiment of a suspension assembly in accordance with the present invention in which a wheel of a two-wheeled vehicle is supported by a two bladder system;

FIG. 13 is another alternative embodiment of a suspension assembly in accordance with the present invention in which a wheel of a two-wheeled vehicle is supported on each side by two separate suspension arms;

FIG. 14A is a view showing how a wheel can be made to camber to the left and 14B to the right by altering the spring rates; and

FIG. 15 is a view showing the control system connected to the bladders of the suspension systems of FIGS. 12 and 13 to control the camber of the wheel.

FIG. 16 is a first illustration of an alternative embodiment of a suspension assembly in accordance with an aspect of the present invention for use in a heavy duty application;

FIG. 17 is an alternative, partially cut-away, view of the assembly of FIG. 16; and

FIG. 18 is a view in cross section of the assembly of FIG. 16 showing the three mounting points for the arm.

### DETAILED DESCRIPTION OF THE INVENTION

FIGS. 2 to 7 of the accompanying drawings illustrate a first embodiment of a passive suspension assembly 100 for a wheel 101 of a vehicle in accordance with one aspect of the present invention.

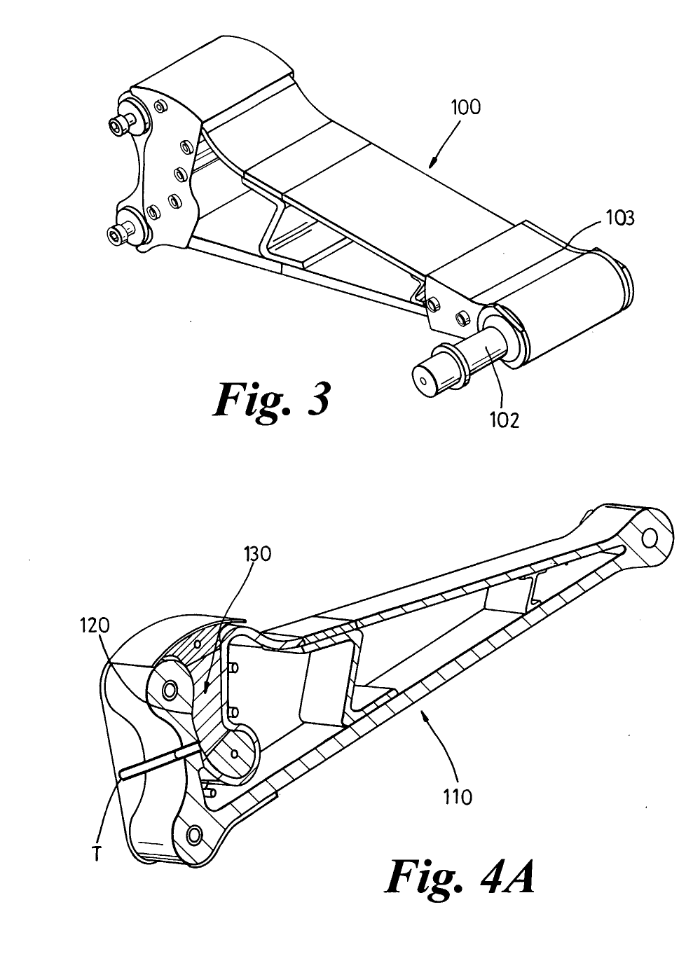

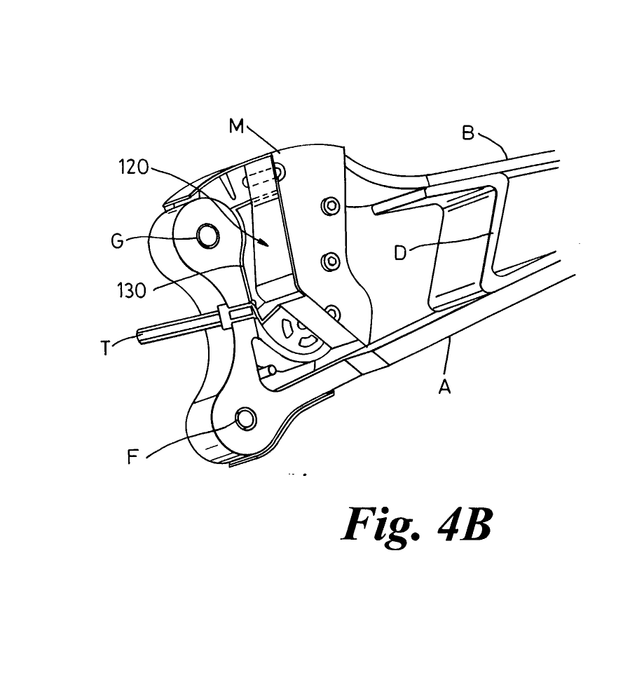

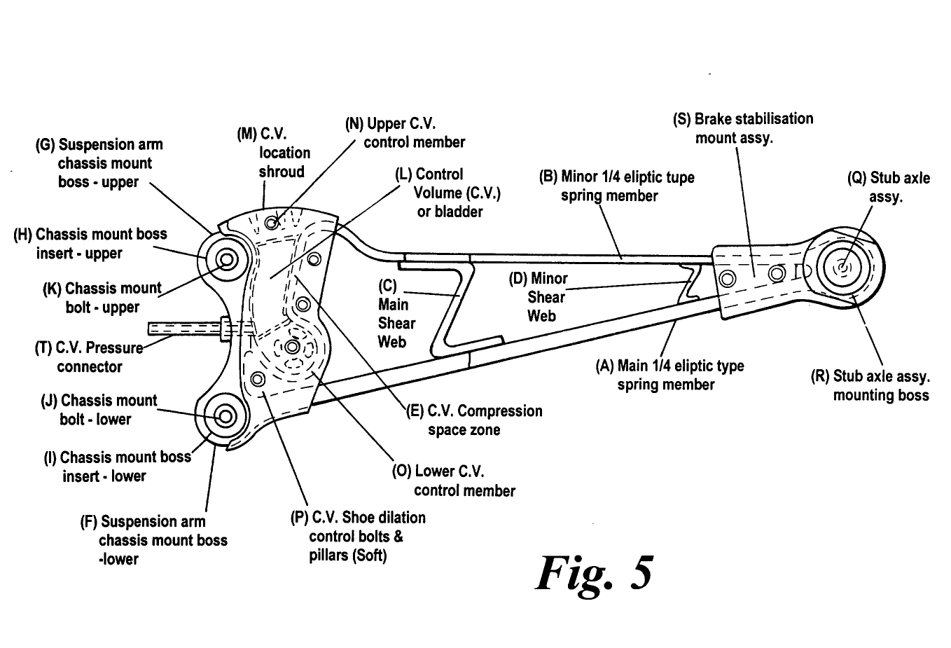

The complete assembly 100 is shown prior to fitting to a vehicle in FIG. 3 including stub axle assembly 102 and brake mounting assembly 103, with the floating shoe arrangement, in isometric view. The complete and partial section views in FIG. 4. A & B show the internals of the assembly. Finally, FIGS. 5 and 6 of the accompanying drawings are cross sectional schematic views.

Referring primarily to those figures, the assembly 100 comprises a suspension arm 110 of unitary construction which at least partially defines a control space 120 whose volume changes as the arm deflects, and a restoring means 130 which is enclosed within the control space 120 defined by the arm 110. The restoring means 120 in this example is a pressurised gas contained within a bladder held within a space enclosed partly by the arm 110 and also by a shroud M which fits around part of the arm 110 to define a closed volume. The arm therefore defines the walls of the space which constrain the gas.

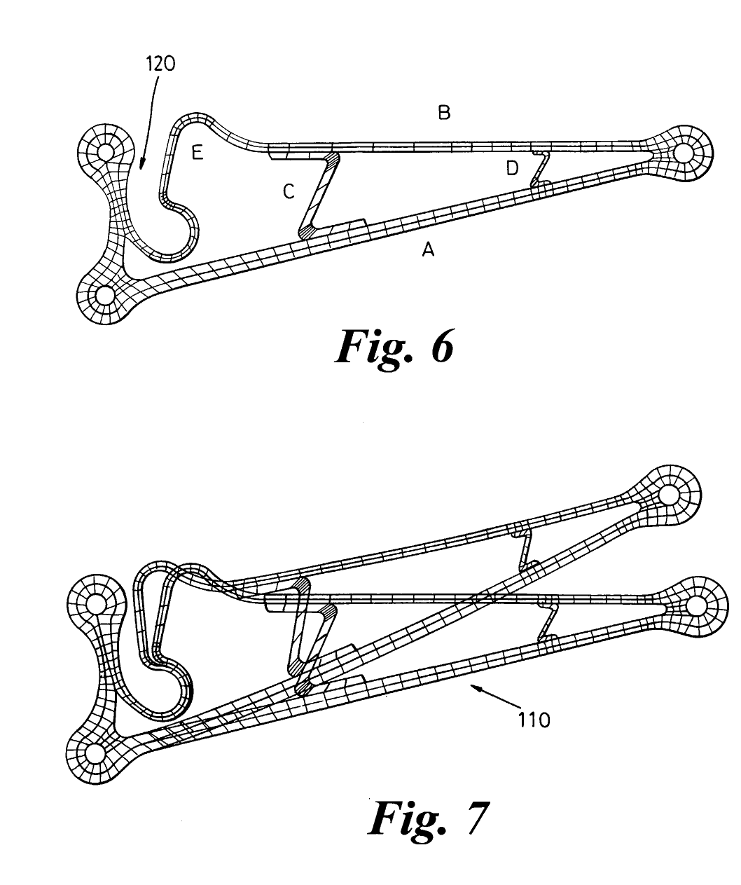

As can be seen in FIG. 7, the assembly is so constructed and arranged that when the arm 110 is deflected under a suspension load, such as the changing forces acting upon a wheel as a vehicle is in motion, the mode of deformation obtained is such that the volume of the space defined by the arm changes. This compresses the gas 130 which thereby acts to oppose movement of the arm 110.

In more detail, the arm 110 of the example is an FRC element of unitary construction (i.e. made as one piece) comprising three main sections labelled A, B and C as well as two further sections labelled D, E in the drawings. These five sections are respectively a first arm member A defining a major ¼ elliptic type spring member, a second member B defining a minor ¼ elliptic type spring member, two interconnecting struts respectively defining a major shear Web C and a Minor Shear Web D, and a connecting member E. Together they define how the arm deforms under load.

The relative location of these sections A, B, C, D and E can best be seen in FIG. 6 of the accompanying drawings as all the other parts are omitted in that figure. It should be noted that sections C & D can be bonded in separately, but A, B & E should form a unitary structure.

The major ¼ elliptic type spring member provides the principle leaf spring capability to the device, and hence the baseline spring capability to support at least the vehicle dead loads. In the example shown the member A is generally planar and extends from a root which is fixed to a vehicle chassis. There are two attachment points to the vehicle chassis within the root of this element, at the rear. These points are through holes across the complete width of the arm. The diameter of the holes is sufficient to provide the load bearing area to transfer the high loads of the reaction forces from the chassis mounting bolts to the main and minor spring members (A & B). There are 4 off identical inserts in the 2 chassis mounting bosses of the arm at the chassis mount end. These components control the load input to the FRC of the arm in the chassis mount boss holes. As indicated in item F & G, this reduces stress concentrations, local distortions under load, and mitigates any fretting between chassis attach bolts and the arm during use, where tensile, bending and torsional loads can be present simultaneously.

The bosses are typically anodised Aluminium alloy or ferrous alloy, e.g. 316 type Stainless Steel to mitigate corrosion in service. Anodised Aluminium alloy is preferred, so as to reduce thermal expansion mismatch to the fibre composite of the arm and provide improved matching to the modulus and hence deflection of the composite material of the arm, in order to enhance joint integrity over life. However in high duty systems, ferrous materials would probably be required.

These inserts could be cast to shape and finish machined, or machined from bar direct. These would typically be bonded into the structure with a rubber toughened adhesive, to ensure long term joint retention and uniform load transfer into the composite socket into which they are inserted. Each insert is ˜90% of ½ the arm width, to ensure the internal faces of each insert remain separated, giving the compliance required to prevent damage to the surrounding composite under deflection of the arm. These are a light press fit into the chassis mount bosses, with areas of relief e.g. 3 off axial undercuts, to produce a shallow (˜0.5 mm) depth pocket for the fixing adhesive. However, a clearance fit can be employed where the adhesive occupies the clearance between the boss and insert.

Chassis attachment bolts pass through the bosses. These would typically be Unbrako type, high tensile carbon steel bolts, since these are the primary means of attachment of the arm to the vehicle chassis and are hence safety critical. In the manifestation shown here, they are M12, with plane shank for load bearing principally in bending. A nut and washer captures the bolt at the in-board end. As is normal practice, interfacing to the chassis mounting bracket shown in FIG. 2.

Being manufactured from plastic composite material, it is also desirable to employ metal inserts at the bolting points to minimise the stress concentration at the load bearing points (F & G).

In this first embodiment, the offset of the stub axle required to give clearance to the wheel and tyre, results in a torsional moment on the arm. This results in twist of the arm, and a negative change in wheel camber angle, which increases with vertical deflection of the arm. To reduce this to an acceptable value, e.g. less than or equal to 5 degrees, the material composition and the geometrical design of the arm has been manipulated to yield an optimum of bending and torsional stiffness along it's length. This can only be achieved with fibre composite materials, where these properties can be manipulated by the following criteria for the material,
fibre type; carbon fibre has high specific properties (modulus, strength) vs. cost and strain to failure. However in principle all other types of structural composite fibre could be employed. The fibre type dictates the primary properties of the composite material
binder type; resin modulus, toughness and strength dictate the properties of a fibre-resin composite in a secondary way vs. the fibre content. However, other binders can be used.
fibre angles; these can be varied almost with complete freedom within the material, between 0 & 90°
laminate layup; in principle the composite can have different fibre directions throughout the part geometry and it's thickness.

In this way the properties of the arm can be given a level of local performance not possible with other materials. This is a significant enabler in design of the arm.

The design shown in FIGS. 2 to 6 is sized for a town micro-car of light weight, to carry 2 passengers. This requires a nominal dead load capability at the rear wheel/suspension of approximately 2.5kN. The arm must support this with a deflection of no more than 75 mm at twice that load. The overall length of the arm shown was 420 mm from the chassis mount boss centres to the stub axle mount centre. This was achieved with the following materials content for Item. A:
XAS type Carbon fibre and Epoxy resin with nominal volume fraction of 60%
75% of section thickness (at core) ±45o fibre angles (relative to length of axis of arm)
25% of section thickness (at core) ±Oo fibre angles (parallel to length of axis of arm) on the outer faces of the arm (skins)
the section thickness tapers from the chassis end to the wheel end.

This produced an acceptable torsional (twist) resistance and acceptable bending stiffness, with a strain level in critical areas sufficient to allow acceptable fatigue life.

This was used throughout this element, with local variations where interfaced to the other composite spring elements C, D and E.

The Minor ¼ elliptic type spring member B of the FRC arm serves a number of purposes, critical to satisfactory operation of the component. Its first purpose is to stabilise the deflection of item E (the connecting member). It prevents adverse dilation of item E during deflection in suspension movement. Without this element, item E would not deform in a controlled manner, closing the space, and hence giving the required pressure changes from which the variable stiffness arises.

Its second purpose is Load transfer from the deflection of the main spring element A into item E. It provides a secondary spring behaviour to act in concert with item A, to increase baseline spring rate of the arm. It also offers an increase in baseline torsional stiffness of arm, by coupling item A and G together at the root of the arm where attached to the chassis.

This section is manufactured from the same materials and layup proportions as item A, sized to the reduced thickness. Unlike item A it does not taper significantly from the chassis end to the wheel end. The thickness is dictated by the need to create a compromise between sympathetic bending to item A and retention of acceptable geometry for movement transfer into the restoring means item E, in order to
prevent mechanical overload at the root item A, where it meets the fixings at the fixing regions of the arm, which are the ends in this example;
to produce acceptable stress distribution along the whole arm FRC component.

Item B is unitary with Item A and is preferably manufactured at the same time. In this case, where the different thicknesses and layups of the FRC material are blended together in a way that overlaps different layers from different to produce the changes in section and layup by a ply-drop-off arrangement as is normal practice with complex composite parts. In this way no local areas of gross material discontinuity occur. This is a complex process, but can be employed with similar layups and geometry to the pultrusion manufacturing technique described previously.

Just as with other elements of the FRC component of the assembly, the fibre reinforcement materials employed in this element do not necessarily have to be uniform throughout their part geometry or thickness. Any number of combinations throughout the element, or the structure as a whole, can be employed, providing the suspension operating envelope, (principally load & deflection capability) is satisfactorily met, with acceptable capability for overload and life requirements.

The Major & Minor Shear Webs C and D perform the following functions critical to operation of the Smart Arm. They act to stabilise the deflection of item E (the connecting member) and Load transfer from the deflection of the major & minor spring element A & B into item E; these items prevent adverse bending modes developing between and within items A & B. Specifically these elements prevent adverse dilation of item E during upwards deflection of the suspension. Without these elements, item E would not deform in a controlled manner, closing the control space, and hence giving the required pressure changes from which the variable stiffness arises. The principle mode of deformation suppressed in item E is outwards away from item A (or inwards) under compression during upwards deflection of the suspension. Buckling of item E is also suppressed under the same load regime.

The shear webs also provide an increase in baseline torsional stiffness of the assembly, by coupling items A and G together at the root of the assembly where attached to the chassis; these components are designed to couple items A & B together, such that in axial torsion along the length of the arm, items A & B operate in concert, producing substantially greater torsional stiffness than if not coupled.

The shear web sections are manufactured from the same materials as item A; however a wholly 45o layup is employed to maximise shear stiffness to resist the torsional loads, and minimise bending stiffness to optimise coupling between items A & B (as described above). The thickness is similar to that of item B.

The length of the foot area (parallel to and in contact with items A & B) of the Z-shaped major & minor shear webs C and D is critical in providing satisfactory load transfer through the elements to items A & B, being ˜⅔ the length of the span section between Items A & B. The radii of the joints formed between the parts controls the stress levels between the shear webs C & D and the spring elements A & B, being ≃½ the thickness of the adjacent spring element at that point.

Items C & D can be manufactured as an integral part of the FRC component of the Smart Arm, as in the example shown in FIG. 6. However, these can be manufactured separately and bonded in place using a compatible paste type adhesive, e.g. epoxy.

The final section, the connecting member E is also made as an FRC component. The thickness, geometry and material lay-up of this element of the FRC component of the arm is critical to satisfactory operation of the suspension assembly. This element of the component behaves like a rudimentary ‘clock spring’ type radiused component, feeding the mechanical forces from the C.V. compression zone into the root of item A adjacent to the lower chassis mounting boss. The typical deflected shape of the assembly, and in particular item E, is shown in FIG. 7 under different loads (no deflection and full deflection).

The geometry (major and minor radii), material and thickness allows a rotation of the end of the element on a trajectory such that,
The flat face of the control space, i.e the wall of the connecting member stays largely parallel to the back face of the connecting member, which in this embodiment is a face of a chassis mounting boss connection land which joins the upper & lower bosses to provide the load transfer path into the chassis connections. This ensures the maximum gas displacement at full suspension deflection and hence the maximum spring rate change from modulation of the gas pressure.
The stresses at the root of the radius remain below those likely to cause fatigue or mechanical overload induced material failure
Torsional coupling of the main and minor spring elements, items A & B also occurs at this point. This dictates the torsional stiffness of the FRC component of the arm.

Similarly, the same criteria apply to the upper section of this element, which is equally critical to satisfactory operation.

The connecting member E is shaped to define a space between two opposing wall sections which accommodates the restoring means that resists the deformation of the space as the arm flexes, thereby providing control of the spring rate of the arm. By arranging for the arm to flex when loaded in a controlled manner the arm and the restoring means together provide a simple and elegant suspension assembly with no moving parts—all movement being accommodated by deformation of the parts only. The restoring means may be wholly contained within the space giving a self-contained assembly which can be tuned by altering the restoring means in the space.

The restoring means may be either a gas or a fluid or a shaped, collapsible solid (such as a flexible polymer block) although a gas is preferred. In the embodiment shown, this may be contained within a bladder as shown in FIG. 5 which is located in the space defined by the connecting member.

To prevent the bladder spilling out of the space a shroud is provided which fits around the connecting member to close off the space.

The bladder, restrained by the wall sections and the shroud is a flexible, pressurisible gas tight cavity into which controlled gas pressure can be fed through a high pressure connection (item. T). Being flexible, as the suspension arm deflects, the volume occupied by the gas is reduced, pressurising the gas trapped inside. The increase in pressure so produced within the bladder results in the need for increasing mechanical effort to achieve the suspension deflection. This manifests itself as an increase in spring rate for the whole arm assembly.

In the arrangement shown, the bladder is manufactured from a rubber type component, typically PUR, reinforced with highly flexible fibres, typically Kevlar, to increase the durability of the structure. The contact faces to the side walls of item M, the shroud, are coated with a solid lubricant such as PTFE to mitigate the rubbing effects resulting from relative movement between the sidewalls of the connecting member, the bladder and the shroud during suspension arm deflection. The component is moulded as a fully closed volume, with an integral pressure outlet tube for connection to a pressure modulation circuit outside of the cavity if required. In this manifestation it is generally equivalent to a steel tyre valve core in a tyre inner tube. This is achieved by employing a lost foam moulding approach, where the core defining the internal space is dissolved out after moulding of the bladder.

The bladder and pressurising system in the example shown has been designed around a peak pressure of 2MPa at maximum suspension stiffness level and maximum deflection.

As described, a shroud fits over the bladder area of the arm assembly. The purpose of the part is to prevent the bladder from dilating sideways out of the space. This ensures that all of the deflection of the bladder during suspension movement produces the reduction in gas volume from which the spring rate increase of the arm assembly is derived.

A secondary function of this part is to positively locate a pair of upper & lower control members (items N & P). The function of these elements is to limit the movement of the bladder, such that all of the deflection of item E translates to an increase in gas pressure within the bladder. Manufactured from hard, but flexible rubber like material, e.g., Polyurethane Rubber (PUR), the design of each part is such, that in deforming during suspension deflection, they contribute little themselves to the observed stiffness of the assembly.

The loads exerted in all directions by the bladder (item L) during suspension deflection are thus reacted into the shroud with very limited deflection of the control members items N and O. This maximises the gas pressurisation in the bladder from suspension deflection.

This is achieved by the internal profiling of the control members items N & O. such that controlled collapse and sliding requires low loads from the compression face of the connecting member, whilst providing high resistance to collapse at the interface with the connecting member. This profiling is referred to here as crenulation.

With appropriate selection of rubber density in the form of a foam, a similar collapse capability to the crenulated form can be produced with a monolithic, unprofiled control member, as shown in FIG. 4A.

In the embodiment shown in FIGS. 2 to 7, the shroud M is located on the bladder by a number of bolts and pillars (item P) that run across the width of the arm, clamping the shroud M in position around the space containing the bladder and providing enhanced stiffness to the sidewalls of the shroud.

However, so as to not impede the ability of the shroud M to move relative to items A, B & E, during suspension deflection, it is designed to ‘float on items N & O. There is clearance in the shroud M around items H & I, such that at full deflection of the arm, the shroud M does not foul any other components outside the space containing the bladder.

The shroud may be manufactured from thin 316 type Stainless Steel plates, in this case ˜1.5 mm in thickness. However, a composite plastic, injection moulded plastic, or cast metal item could be employed.

The shroud or shoe can be arranged in two different ways as desired. In a first, fixed arrangement, the ‘shoe’ may be located by transverse bolts, pillars and the internal parts such that as the arm deflects, the shoe moves with the connecting member, whilst maintaining the control of connecting member dilation that is required for efficient variable stiffness control of the arm. The arm deflection is unimpeded by the shoe, designed in geometry to track the motion of the internal components under arm deflection. It also moves relative to the chassis mounting bosses. This version is particularly suitable for applications requiring large arm deflections.

In a second, semi-floating arrangement, the shroud or ‘shoe’ may be further located rigidly by the two chassis location inserts, such that it does not move relative to the arm itself, but motion of the arm under deflection is unimpeded.

The contribution to the torsional stiffness of the arm made by the semi-floating version is inherently higher than that of the fully floating version, but less arm vertical deflection is typically available.

The load can be connected to the arm in many ways, just one of which is illustrated in FIGS. 2 to 6 of the accompanying drawings. In the embodiment shown, the stub axle assy. (item Q) is in two parts that bolt together co-axially with items R, providing the primary fixation of the axle to the arm. A stub axle mounting boss generally equivalent in design, purpose and materials to items H & I is also provided, a pair of metal inserts are bonded (in this manifestation) into the hole carrying the stub axle assy. at the wheel attachment end of the arm.

The stub axle mounting boss supports a brake stabilisation and caliper mount assembly. The purpose of this is to provide a mounting position for the caliper assy. which provides braking by clamping to the disc attached to the wheel hub, itself free to spin on item Q, as is normal automotive practice. In this manifestation two bolts run through the two halves of the assembly. These serve two purposes,
to clamp the two part assembly of item S together, and to the arm at the brake fixing point, thus rigidising the assembly.
To provide location of the brake caliper housing to the mount itself

This mount takes all the longitudinal braking forces, disc brake reaction torque, and arm longitudinal torque forces and feeds them into the arm in a controlled manner. Item S would typically be manufactured from a ferrous alloy, but advantageously from an anodised aluminium light alloy (for reasons covered in item. H & I).

To mitigate any potential fretting behaviour at the interfaces between items A & B and S, the contact surfaces of this item to items A & B are coated in a thin layer of PUR (typically approximately 1 mm thick).

As described herein before, a simple arrangement can be provided in which a fixed volume of gas (or other restoring means) is provided within a control space to control the spring rate of the arm. Although it has been described as a gas in a bladder, it could take the form of a rubber or polymer material provided in the space. In this mode the gas pressure is pre-set by the vehicle user to a programmed level, which is locked into the bladder.

In a more sophisticated arrangement, the assembly could be modified to permit the amount of medium in the space to be varied, thus allowing for the spring rate to be varied. This requires a valve to be provided for ingress or egress of medium to/from the space and a supply for pressurising the space. Alternatively, some other means of varying the properties and or behaviour of the restoring means may be provided.

In the example of FIGS. 4A and 4B an optional pressure valve is shown. The valve may comprise a high pressure connector to which a suitable pressure resistant tube is bonded into the bladder (item L) at manufacture. A suitable tube then connects this to the pressure modulation circuit to complete the pressure control capability within the arm.

To take full advantage of such an active, variable rate, suspension arrangement, a control circuit may be provided which controls the pressure of the medium within the control space, and hence the spring rate in response to measurements taken from one or more sensors. These may comprise strain gauges which measure the strain in parts of the arm or sensors which measure deflection of the arm.

To provide effective data regarding the strain/deflection in the structure the strain/deflection sensors are placed in or on a suitable area of the FRC structure. In this case, a single electrical resistance type strain gauge (S.G.) was applied to the structure on the outer surface of the major spring ¼ elliptic type spring member (item. A described below), in the position indicated by S.G. in FIG. 7 of the accompanying drawings. This provides the full range of response for the full deflection of the arm. Arranged with the principal tensile axis of the S.G. aligned with the longitudinal axis of the spring (running chassis boss end to wheel boss end), the response is principally a tensile response from the outer face of the arm in tension itself due to bending of the arm. If an orthogonal multi-axis gauge assembly is used, strain across the width of the arm could be measured. This principally indicates torsion in the arm component and can be used in condition monitoring.

Providing an input to a suitable control system in this way is sufficient to allow the full range of vertical movement under chassis response in operation to be captured and fed to the suspension control ECU for processing by the chassis control algorithms for the chassis response required, e.g. anti-roll, where S.G. values for arms on either side of the vehicle are compared. Stiffness is increased in the arm with the greatest deflection (and hence indicated strain), thus counteracting the roll resulting from one arm deflecting more than the other arm on the same axle. This confers an anti-roll behaviour to the vehicle chassis, in this case an active capability.

Other active suspension behaviours mentioned previously may be implemented in a similar way, being within axle groups or between axle groups, or some combination thereof. A single S.G. is the minimum required for achieving this.

Use of multiple such sensors on the arm component allows more complex monitoring of the arm response, and the comparison of sensor responses within the arm can be employed to produce more complex control signals and hence more complex programmed response from the arm.

The suspension arm of FIGS. 2 to 6 has been described only in relation to a very simple suspension application in which all of the load from a wheel passes through a single arm to the chassis. The applicant has realised that many other advantageous arrangements are possible.

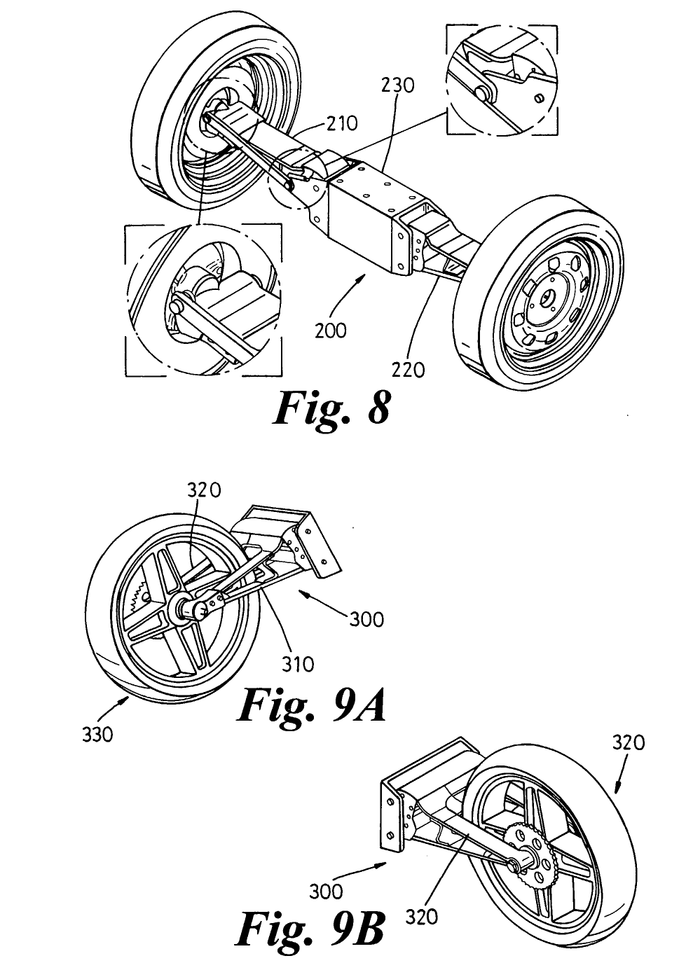

In vehicles with greater than two wheels, a dual transverse form of the trailing arm 200 shown in FIG. 8 is possible for both front and rear suspension, in which the ¼ elliptic becomes a ½ elliptic with a two arms 210,220 back to back mounted to a common ‘yoke’ 230 attached to the vehicle chassis in transverse fashion along it's centre line. They could also be a single common moulded part, thus eliminating the yoke.

In this case, for example, the stub axle mounting boss carries a modified version of that seen in FIG. 3 for the baseline trailing arm version described previously. Interfacing to the stub axle assembly is through two metallic inserts bonded into the cylindrical cavity in the FRC arm boss. However, this joint is free to rotate, through use of e.g. a Glacier bush type lubricated plain bearing insert at the interface between the boss insert and securing bolt running through the boss inserts and brake stabilisation and caliper mount assembly. This is now a stub axle carrier assembly. Thin face bearing type side thrust washers are interposed between the brake stabilisation and caliper mount assy. and the securing bolt, to effect a suitable axially constrained, but rotary free mounting to the wheel attachment boss of the arm. The stub axle itself is attached to a feature in the metallic brake stabilisation and caliper mount assembly at 90° to it's axis of the boss.

This securing bolt is flanged above the centre line of the boss and carries a bush with rotary freedom, positioned above the axis of the boss. To this is attached the control link which achieves camber compensation in the suspension assy. under deflection. The other end of the link is attached by a similar arrangement to a protrusion from the chassis mount sub-frame. In this way, the link produces a camber compensation since when the suspension is deflected, the link, being a set (but potentially variable length for camber tuning) produces a turning moment on the stub axle carrier assy., such that downward deflection of the suspension arm rotates the stub axle carrier assy. outwards, acting to retain the angle of camber of the wheel to the road surface. Clearly by having variable settings for the relative positions of the two centres allows more or less camber compensation to be achieved.

The brake caliper torque reaction forces are still carried through the mount assembly to the arm as with the baseline trailing arm example.

The applicant further envisages that a suspension arm such as that shown in FIGS. 2 to 7 can be used as a spring, or combined spring damper, within a conventional multi-link suspension arrangement, where the following advantages would still apply,
weight reduction
adaptiveness/smartness; variable stiffness & damping
ride height control
compactness
torsional limitations of baseline trailing arm manifestation completely eliminated

In one notable example of such an arrangement, an arm may be mounted in a plane at 90 degrees to suspension movement. This would allow a very shallow suspension system, since through the use of bell cranks, the up/down suspension motion is translated to back/fore motion in the plane of the chassis floor pan. This approach similarly eliminates the torsional limitations of the baseline trailing arm manifestation, since these are eliminated by conventional (or similar) multi-link suspension to which the arm is attached. This is particularly true in the case of a ride height controlled example, where tandem units would be mounted at 90° to the view shown, with the arm boss axes at 90° to the vehicle floor pan. The total height for this installation would then be little more than that of the arm width, e.g. 100 mm. This would be particularly useful in Sports car applications, where the vehicle height is required to be as low as possible. The units would be nested a phased at 180o to minimise areas taken up. Clearly they could be mounted at any angle required to fit the drive train and chassis configuration, with the load path between wheel movement and suspension motion plane being accommodated by the connecting bell cranks (or similar motion translation devices). The gearing allowed by the bell crank itself further enhances the tunability of the assembly. Clearly, this approach would also allow a wider range of deflection/load characteristics to be implemented.

Whilst a suspension assembly in accordance with one aspect of the invention may be incorporated into the design of a four wheeled vehicle it may also find application in the design of two wheeled vehicles such as motorcycles. A typical implementation is shown in FIGS. 9 A & B. The design is similar to the trailing arm of the first embodiment, but as a monolithic, dual sided suspension arm allows greater torsional stiffness to be achieved in the arm. The wheel runs between the two arms of the suspension fork.

The forked arm is manufactured as described for FIGS. 2 to 6 but rather than having a constant cross section across its width a slot for a wheel to occupy is provided such that the component defines two arms. The slot may be produced by machining from a section of an FRC component of constant cross section; typically using a diamond saw, router, or milling cutter system (or similar). Clearly the profile cut will dictate the native spring rate of the arm, as it defines the section width in each arm of the fork. In this way, vary many native suspension rates can be generated from a common arm precursor, just by a change in machining profile to change the width of the LHS & RHS arms of the fork.

Primary torsional loads resulting from axle offset in the rear wheel trailing arm assembly, as observed in the 4 wheel trailing arm example described above are eliminated. This single component replaces the swinging fork, bearing, bushes, coil spring and damper typically employed for the rear suspension of contemporary motorcycles. This results in reduced un-sprung weight, which is critical on light weight-high performance motorcycles, and offers similar potential for active suspension capability, as in the 4 wheel vehicle example described previously.

In a further, more sophisticated arrangement, two separate, self-contained, spaces can be defined in each half of the unit across it's width (adjacent to the connecting member), each containing a gas or other medium defining a restoring means. This allows for a variable stiffness to be employed within each arm of the assembly. A similar effect can be achieved by using two suspension assemblies (arms and medium) to define the two arms of the fork.

The embodiment shown in FIGS. 9A and 9B of the accompanying drawings can be readily arranged as a dual chamber device.

The design shown can be adapted for double longitudinal wishbone steer-able type front suspension, by profiling the arms so as to allow rotation of the front wheel around an axis within the width span of the arms to achieve steering within the assembly. A hub bearing capable of rotation relative to the spindle in a plane normal to the steering axis would be required, as is normal practice for this type of ‘hub centred steering’.

Providing that each arm of the “fork” can be controlled so that their spring rates can be varied independently, it is possible to provide rear wheel steering to the motorcycle to compensate for instabilities within the chassis and wheels, by effectively changing vertical rear wheel alignment. This ‘cambering’ of the rear wheel is a very effective steering measure at high speeds, where such chassis responses are of most benefit. Again, it is the individual deflection/strain signals from the LHS & RHS arms of the unit that are used as programming signals for the variable pressures to be applied. Active steering is thus achieved by application of a torsional imbalance between left hand side & right hand stiffness, which will misalign the Front & Rear wheels, producing the rear wheel steering effect.

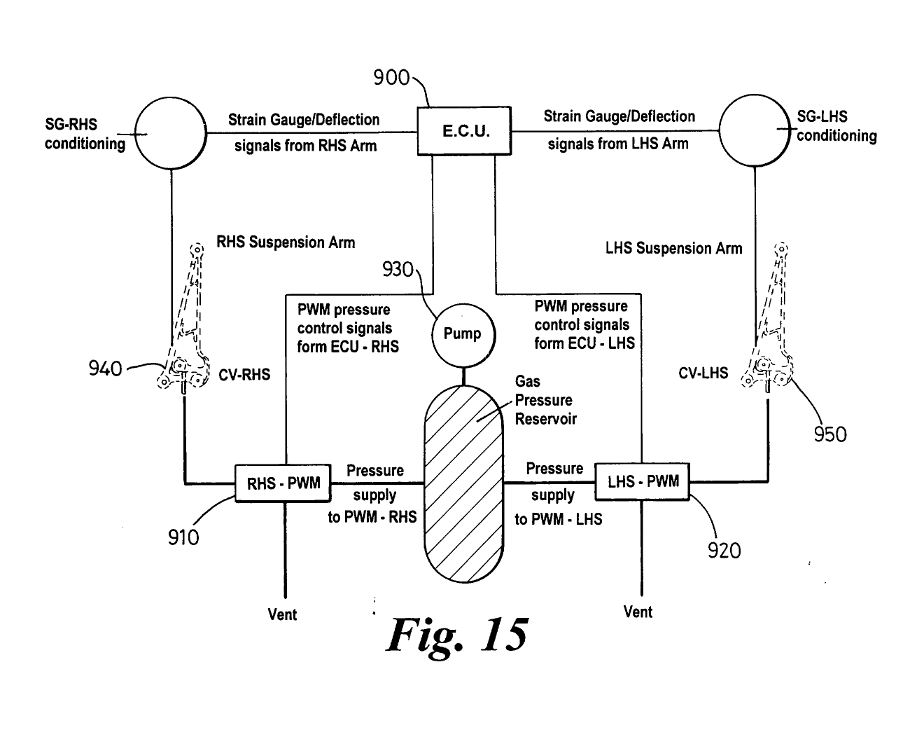

The effect of changing spring rates at each end of a rear wheel axle can be seen in FIG. 14 of the accompanying drawings. In both figures a rear suspension is viewed from the rear. As shown, the suspension comprises two arms 810,820 which support respective axle support bearings for an axle 830 of a rear wheel 840. In FIG. 14a the spring rate of the left hand spring (viewed from the rear) is lower than that of the right. The weight of the bike acting onto the wheel pushes the wheel over. In FIG. 14b the spring rates of the left and right hand springs are swapped so the wheel cambers the other way.

This capability could also be employed to apply steering compensations to improve overall chassis stability, or be programmable to allow chassis tuning by the rider to change the steering characteristics of the chassis. This could have particular utility in motor cycle racing, where race track, weather conditions and track position related response could be programmed into the unit to operate in real time.

Similar behaviour can also be employed to control the twist in the arm under chassis loads in use, by applying torsional compensation to the arm. For example if the arm is twisting in a clockwise manner (from the rear—as viewed in FIG. 9.B.) under dynamic chassis loads, then the RHS pressure would be increased to mitigate this, effectively applying a torsional compensation to the arm. Improved chassis stability and chassis dynamic response will result.

It will be appreciated that many modifications can be made to the detailed design of the embodiments described hereinbefore whilst remaining within the scope of the present invention. To enhance durability of the suspension system, the following could be employed.
wiper seals/flexible external gaiters and solid lubricants within the assembly to eliminate dirt ingress into the closed volume and minimise friction and wear between the shroud and the arm respectively.
the FRC section of the arm could be coated by a suitable means with a thin coating of PUR to prevent damage from road debris to the material and structure; if necessary, the whole assembly could be sealed in a flexible PUR cover which was removable for periodic inspection, but did not significantly alter the mechanical behaviour of the arm.

It will also be understood that the provision of a suspension arm as described herein before whose spring rate can be varied allows a designer to implement many functions within an overall suspension design. Some of these are listed below, although the list should not be considered to be exhaustive. Protection for any of the functions in the list may be sought by the applicant through this application:

### Function 1—Active Suspension Capability

The control volume in each arm then gives the adaptive stiffness to each wheel, such that active ride & handling can be achieved in the vehicle, by suitable manipulation of the bladder pressure under the programming from the deflection/strain sensor response in each arm. The active ride & handling behaviours are typically defined as,
Anti-roll; improvements to vehicle ride and grip can be achieved by this method. The assembly achieves this by sensing the deflection in real time on the LHS & RHS arms. From this, the difference indicates the degree of body roll. By stiffening the arm on the outside of the turn, the degree of roll is reduced, and ride quality and cornering grip are thus improved.
Anti-squat; squat is the lowering of the front of a vehicle under braking forces. Where a suspension assembly of the kind shown in FIGS. 2 to 7 is applied at each of the 4 wheels of a 4 wheel vehicle (but not precluding those with greater than 4 wheels), this mode can be employed. The difference in deflection/strain between the front arms and rear arms indicates the degree of squat. If the front arms are stiffened, the deflection and hence squat will be reduced. This is further enhanced by corresponding reduction in stiffness from the rear suspension. This mode can be employed with two wheeled vehicles, where front end squat (or dive) is a significant hazard to vehicle control under heavy braking on motorcycles, when steering and chassis stability are seriously affected.

Clearly both these active-suspension modes can be employed simultaneously to the vehicle, to provide the full range of chassis control behaviours described the full range of chassis control behaviours described.

### Function 2—Load Compensation

If the stationary height of the vehicle is to be maintained with variable payloads weights in the vehicle, then the system can automatically sense the deflection/strain at vehicle start up and apply a compensating pressure change to achieve the nominal value required. After this the system behaves adaptively, as is the normal mode of behaviour, with active chassis capability. However, load compensation does not rely on active chassis capability, and could be applied independently to a vehicle with this system.

### Function 3—Ride Height Control

In all manifestations shown, when the damping medium pressure is increased, the rate of the spring increases. As a result the ‘ride height’ is affected—the vehicle will ride higher. In most cases this is not a problem.

However, where ride height control is required separate from stiffness, it is necessary to be able to manipulate ride height independent to stiffness control. This can be affected by providing a second space for a damping medium, below, and opposed in operation to the existing stiffness control space above. In this way, the ride height can be reduced by pressurisation of this space, in order to counteract the apparent increase in ride height when the stiffness modulation above is activated. Unfortunately, the resulting geometry is substantially more complex to manufacture and has reduced torsional resistance than the equivalent single trailing arm with single stiffness modulation as shown in FIGS. 2 to 7. Where torsional stiffness is a lesser issue, e.g. in a system employing the Smart Arm as a variable spring, within a conventional multi-link suspension assembly, this is less of an issue. However, a preferred means of achieving ride height modulation is as follows.

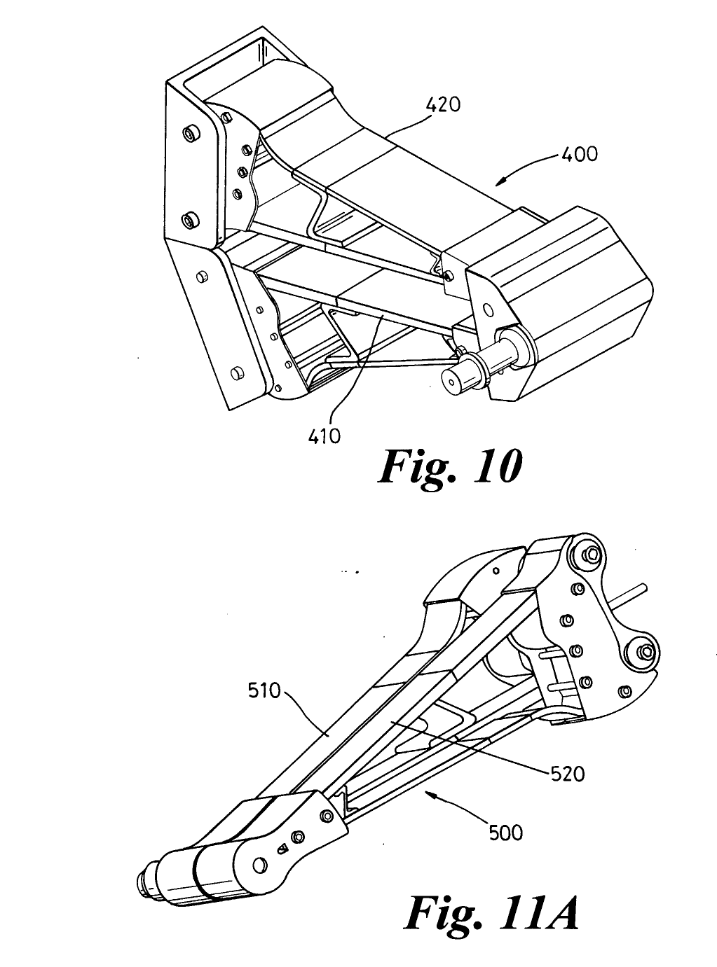

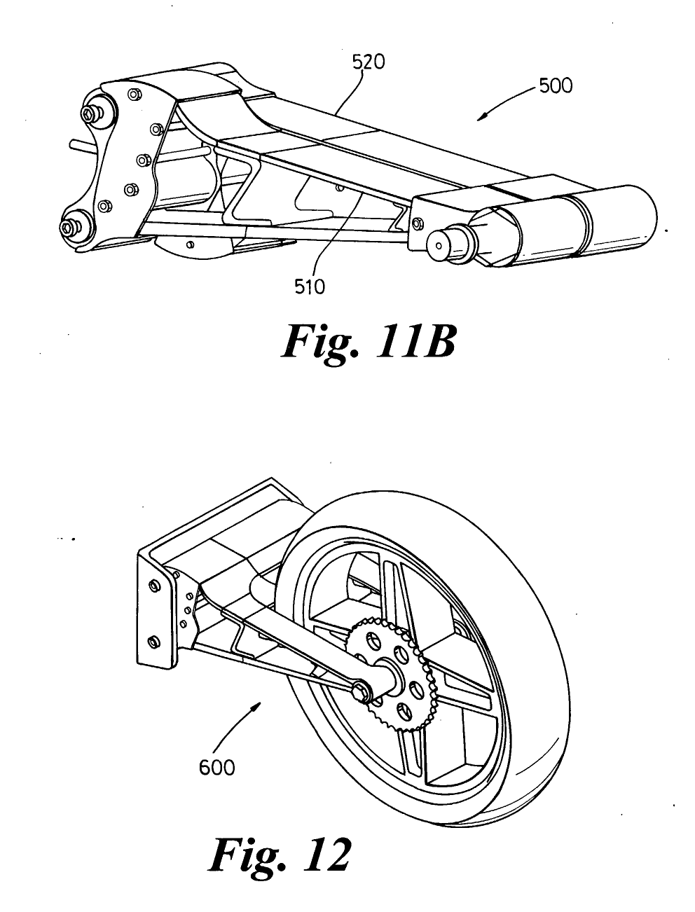

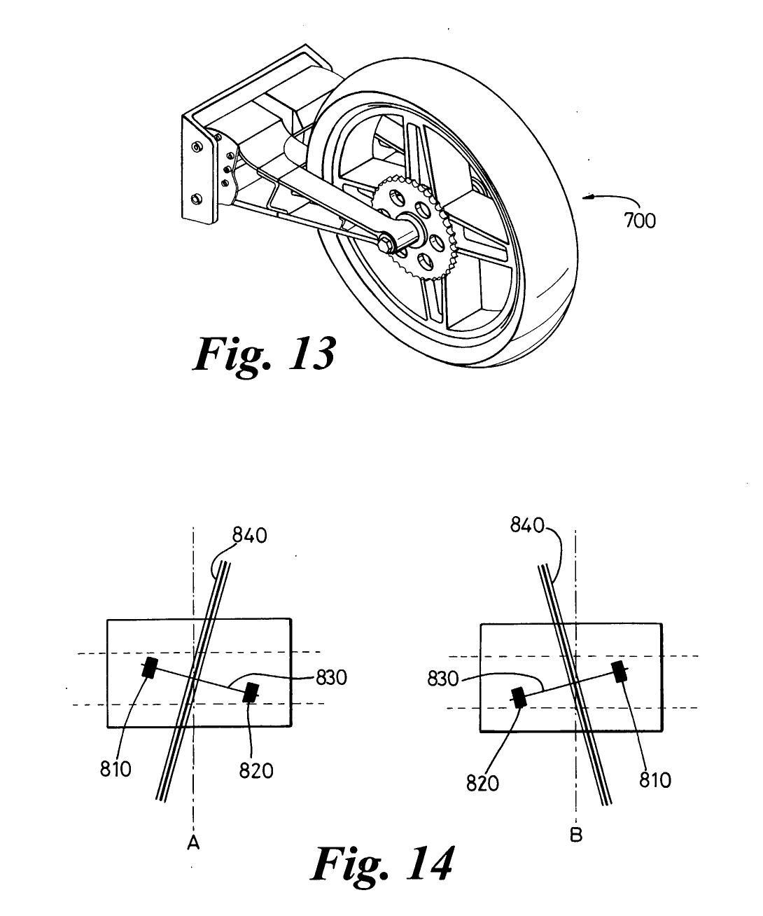

Ride height modulation can be achieved by a vertical pair of mutually opposed arms as shown in FIG. 10. This is a quarter elliptical, trailing arm example, but the same approach can be employed in the transverse and semi-elliptical, dual arm descriptions given earlier. Pressurisation of the lower CV causes the arm to deflect upward, resulting in the vehicle lowering.

Typically both of these arms would be smaller in dimensions than the equivalent single arm for the same load carrying capability, due to the enhanced structural efficiency offered by the geometry employed in mounting dual arms.

An alternative arrangement has the two mutually opposed arms operating in tandem, stacked width ways, such that the chassis and wheel mount bosses are co-axial, see FIGS. 11.A & B. In this way when the ride height adjustment arm (the inner most unit) operates to reduce suspension height to nominal, it has the added benefit of producing a torsional moment at the stub axle (extended to connect both arms at the wheel connect boss). This acts in concert with the already enhanced torsional stiffness arising from the two arms operating collectively on the single stub axle, and counter acts the moment experienced due to the vehicle dead weight by, reducing the twist observed for the whole assy. In this way, as the load on the suspension increase, so does the torsional compensation from the ride height adjusting arm. Further advantages are compactness, a minimum number of parts, and increased fail safe, in that both arms must fail to produce baseline, unassisted suspension failure.

### Function 4—Further Optional Behaviours

System capability can be programmed to a control unit for the restoring means pressure, such as a vehicle ECU. In this way, the capabilities can be selectively enabled, such that the vehicle supplier can implement levels of behaviour and system performance according to customer requirements. In this way, a common system can provide different levels of performance according to the specification purchased by the vehicle user. Clearly there are cost benefits to the vehicle supplier as a single system is provided, and at no cost and with just a software action, greater capability is provided to the vehicle user with increased revenue to the vehicle supplier.

Similarly, system upgrades through changes in control software can be made available from the vehicle supplier as cost options.

A range of modes and functionalities could thus be provided to the vehicle user, with capability for user tuning available within each software envelope supplied, e.g. user sport/comfort mode selection, or user ride height control for terrain adaptation.

### Manual Mode

In this mode the system is under manual control, with either real time or passive (pre-set) type behaviours.

### Pressurisation Circuit And Control of Restoring Means Pressures

Pressures of up to 1Mpa are typically employed in the bladder to double the effective spring rate.

Typically a single stage electrically powered, high speed rotary vane air pump can produce the pressures and the flow rates required to achieve the response times indicated above. Alternatively a positive displacement pump can be employed. Alternatively a tandem pump-reservoir system can stage the pressures to the central pressure reservoir. This has the advantage of low cost components and allows pressure re-cycling and improved system mechanical efficiency, whilst inevitably being less compact.

The central reservoir is maintained by the pump at a pressure sufficient to supply the range of pressure changes required from 4 arms on say a 4 wheeled vehicle, such as small passenger car. This acts as a buffer to allow the smallest pump assembly and hence power requirements for the system.

Pressure is metered to the restoring medium in the control space of each arm by individual pressure control valves. These would typically be of PWM type, where full reservoir pressure is applied to a control space attached to the arm by a length of pipe. Where a 2 stage pressure supply system is employed, the pressure is bled off to the 1^{st} stage pressure reservoir for recycling to reduce system power consumption. In a single stage system the pressure is bled out of the system. The control pressure is then locked into the arm at a level dictated by the deflection response/strain signals from the sensors in the arm, or by control levels established independently by other sensors within the vehicle/chassis under the control of an ECU.

The Suspension system ECU monitors the sensors response and applies the required behaviour to the arm (and damping elements were employed) as defined in the algorithms for this purpose embedded within it.

### Function 5—Suspension Damping

### 5a—External Damping

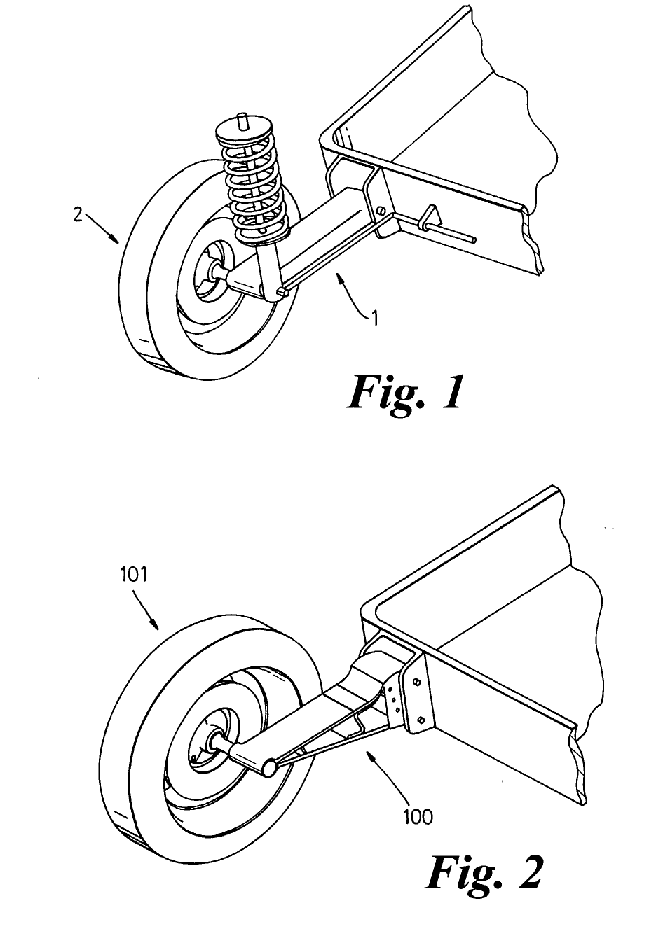

This employs a separate damper to achieve the suspension movement damping required for acceptable chassis behaviour. This is typically a cylindrical positive displacement device employing a viscous fluid as the damping medium. This would be attached in the normal fashion to the stub axle assembly at a location in board of the wheel, similar to that shown in FIG. 1 of the accompanying drawings. This would carry the suspension deflection limiter, typically a PUR bush, called a bump stop. In this way the mechanical forces and deflection of the arm are independently limited.

### 5b—Integral Damping

The gas pressurised space is connected to the pressurisation circuit as described above. If integral damping is required, this can be achieved by employing separate pressure reservoirs which may be remote from the arm. If the arm and it's pressure circuit is filled with a typical hydraulic suspension damping fluid up to a point where it partially fills the gas reservoir, then the movement of the fluid in the circuit to the reservoir can be employed in the following ways.
deflection of the arm displaces the largely incompressible hydraulic fluid that produces a reduction in volume of the gas trapped in the reservoir, resulting in a pressure increase there in
restriction of the hydraulic fluid flow in the circuit will produce a damping effect in the fluid movement, and hence the arm movement.
control of the effective size of the restriction, or orifice will control the amount of damping achieved; the damping level can be set, or variable
if the orifice can be changed in real time, then active damping capability is available
   Orifice control can be achieved
manually, e.g. rotation of a variable orifice element (occluder) within the circuit
mechanically, e.g. by use of an electrical motor and gearbox. A small motor would be required, as the torque-angular velocity-rotation angle range is very limited.
multiple orifice-disc assemblies can be employed in series or parallel to change the baseline capability of the system to give a modular damping capability range for different applications. Some or all of these could be under active control, to give more scope for damping range and response refinement

Less than 1 revolution of the variable orifice would be required to go from max. to min. damping values (typically ½ revolution). The variable orifice could be a slot of variable width in a thin disc rotating between inlet and outlet holes in a sealed cavity within the fluid flow control block, through which the fluid in the arm pressure circuit must pass. Driven by a gearbox co-axially, or tangentially, the damping response is achieved by rotating the disc to position the variable slot with a greater or smaller effective orifice, according to the damping required. In the event of failure in the fluid control assembly the occluder disc would be spring loaded such that it fails in a fully open position. In this way the suspension system cannot become locked and be unable to move if there is failure in the electrical control system.

The bore and length of the connection media between the space in the arm and it's reservoir is matched to the fluid viscosity and suspension movement required during system design, in order to ensure that the minimum level of damping for safe operation of the vehicle is achieved in the event of failure in the fluid control assembly, giving inherent safety to the system.

### Function 6—Full Active Suspension Mode—Active Chassis

In active mode the damping employed would be under ECU control, itself programmed by the deflection/strain sensors in each arm on the vehicle.

Alternatively, ancillary sensors, such as vehicle accelerometers, power train levels, etc. and similar can also be employed as inputs to the ECU to control both pressure (as previously described) and damping levels within the system, to achieve full active chassis control.

### Function 7—Additional Active Steering Capability From Fitment To Motorcycles

When a suspension fork with two independently controllable arms (or predominantly independent) is employed then it is possible to allow chassis tuning by the rider to change the steering characteristics of the chassis. This could have particular utility in motor cycle racing, where race track, weather conditions and track position related response could be programmed into the unit.

A suitable system is illustrated in FIG. 15 of the accompanying drawings. It comprises an ECU 900 which controls two fluid control valves 910,920 that connect left and right suspension arms 940,950 of a fork to either a vent or a source of pressure 930. Opening and closing the valves controls the pressure in each arm, and sensors 960,970 feed signals to the ECU indicative of the behaviour of each arm to permit a degree of closed loop control to be attained.

If the system is operated in real time under rider control, the rider could manipulate the steering response from the chassis in order to optimise the turning capability for each turn on the course. In this way low radius, tight bends, where speeds are low and a high rate of turn is required could employ a different steering behaviour to that required for long, large radius curves where speeds are high and chassis stability is of more importance.

In this case, the individual deflection/strain signals from the LHS & RHS arms of the fork of the suspension are used as status signals for the ECU controlling variable pressures to be applied to the arms. These values could be indicated to the rider in a simple graphic, such as an LED bar graph, to provide status and response indication,

In an alternative or additional function, the individual deflection/strain signals from the LHS & RHS forks of the suspension arm can also used as programming signals for the variable pressures to be applied to the arms. This can be used to provide active steering. This is to compensate for adverse vehicle behaviours, in order to enhance the safety of the vehicle. The system would be seen as a safety aid, giving assistance to the rider and so increasing the margin of safety from the vehicle chassis. However, this would not be a primary safety system, since responsibility for this must ultimately lie with the rider.

The principal safety enhancements cases address the following two vehicle behaviours typically encountered by 2 wheeled vehicles, such as motorcycles,

Under-steer: this is where the motorcycle is turning in a manner that will result in the effective radius of turn exceeding that of the actual radius of turn required to negotiate the bend being navigated. This is a common cause of accidents in motorcycles, where the vehicle can,
collide with vehicles on the other side of the road
runs off the road on the wrong side
in the extreme suffers a ‘low-side’ where the front wheel loses grip with the road surface allowing the front wheel and hence the vehicle to slide and the vehicle & rider to fall into contact with the road.

Over-steer: In this case, the opposite of under-steer applies—the actual radius of turn is less than that of that required by the bend to be negotiated. This is also a common cause of accidents in motorcycles where the vehicle can,
collide with objects at the near side of the road
where the rear wheel breaks contact, slides outwards towards the outside of the curve; typically this results in a ‘high-side’, where grip is regained, and the side motion of the rear wheel results in a turning moment at the rear wheel and chassis about the longitudinal axis of the vehicle, such that the vehicle rotates around the rear wheel contact patch and pitches violently towards the outside of the bend. Typically the rider is thrown from the machine and the rider & machine slide on the road to the outside of the bend.

The system would address these safety cases in the following ways,

### Understeer

The rear wheel will be cambered such that the rate of turn is increased, causing the vehicle to describe a lower radius of turn matching that required to negotiate the bend, as indicated by the rider & vehicle inputs. For example, negotiating a LH bend, the rear wheel would be cambered in an anti-clockwise manner (viewed from the rear), in order to increase the rate of turn to the left—all other things being equal.

### Oversteer

The rear wheel will be cambered such that the rate of turn is decreased, causing the vehicle to describe a larger radius of turn matching that required to negotiate the bend. For example, negotiating a LH bend, the rear wheel would be cambered in a clockwise manner (viewed from the rear), in order to decrease the rate of turn to the left—all other things being equal.

### Active Steering System Overview

In order to achieve these responses, the following sensing, and control approach could be employed.

Sensing: the following would be required
accelerometers to give yaw response for the chassis
accelerometers to give rate of turn for the chassis
angle of lean of the motorcycle
angle of rotation of the steering head around the axis of the steering column of the motorcycle (steering angle)
vehicle speed
strain/deflection monitors for the LHS & RHS of the Smart arm

Control: Independent stiffness modulation in the LHS & RHS of the Smart arm

Control Strategy: the following approach could be employed:

The intended radius of turn predicted/planned by the rider can be inferred from the following,
the value of the lean angle
mass of vehicle and payload+rider (as indicated by the at rest strain values from the arm)
angle of rotation of the steering head around the axis of the steering column of the motorcycle (steering angle)

The actual radius of turn predicted by the control system ECU with suitable algorithms embedded describing the chassis behaviour of the particular vehicle to which the system is applied. This value is given by reference to,
accelerometers to give yaw response for the chassis
accelerometers to give rate of turn for the chassis
angle of lean of the motorcycle

These intended and actual bend radius values are compared within the ECU and a corrective amount of rear wheel steer, through which rear wheel camber change is applied. As described earlier, this would address the under-steer and over-steer cases. This would result in improved safety for the rider and vehicle, by increasing the margins of cornering capability for the vehicle.

Clearly the rider can have access to the level of compensation/turn assistance available from the system according to the road conditions and vehicle condition that apply at the time, e.g. wet, tyre wear, respectively, etc.

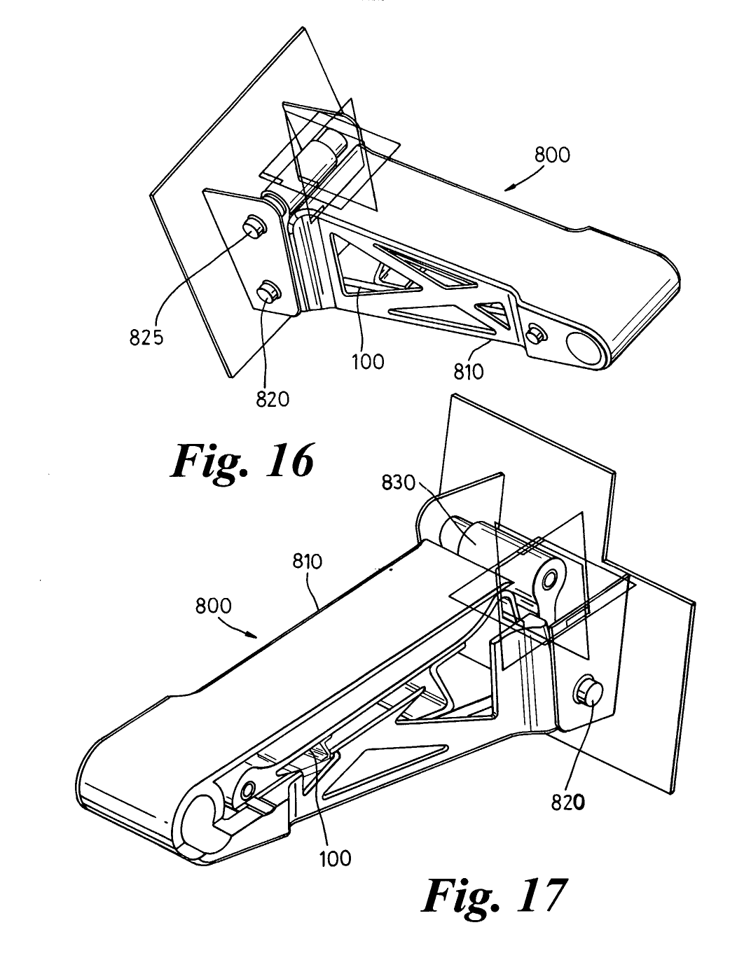

A still further embodiment of a suspension assembly in accordance with an aspect of the present invention is illustrated in FIGS. 16, 17 and 18 of the accompanying drawings. This shows a heavy duty assembly, although the principles are also applicable to lightweight applications.

The suspension assembly shown in FIG. 16 is suitable for supporting the rear wheel of a motorcycle, or one rear wheel (or wheel set) of a four wheeled vehicle.

The assembly comprises a flexible arm 100 similar to that shown in FIG. 2 of the drawings. In addition, the assembly includes a secondary assembly which is implemented to mitigate the inherent self-cambering of the Smart arm with an offset axle.

Primary torsional loads resulting from axle offset in the rear wheel trailing arm assembly, as observed in the 4 wheel trailing arm example described previously are eliminated or at least substantially reduced. As before the flexural support is employed with active control of springing & damping, as previously described in the 4-wheel vehicle.

This is achieved by use of a structural ‘sleeve’ 810 which pivots around an axis formed by the co-located/co-axial lower mounting boss 820 of the flexible unitary suspension component. The pivot is achieved by use of a rotary bearing. In FIGS. 16, 17 and 18 the bearing is a single race ball bearing with inner and outer protective lip seals to protect the bearing operation.

A lower chassis clamp bolt secures both the flexible suspension member 100 and the structural sleeve 810 at this point by axially clamping the bearing inner, flexible member chassis mount sleeve (insert inside the arm at the mounting boss) and chassis mount boss so as to remove all axial play. The sleeve 810 is then free to rotate about the axis through the lower chassis mount boss 820. In this way the sleeve can rotate freely and the resilient member is fixed in the previous manner with a single concentric fixing. This is shown in FIG. 17 of the accompanying drawings.

At the top chassis mount 825 the rigid fixing by a single bolt of the smart arm upper boss to the chassis is as in previous manifestations shown. However, a hard, flexible bush 830 is mounted on the spacer clamped between the chassis mount boss and the resilient member chassis mount sleeve. This acts as a ‘bump’ stop, to limit rotation of the structural sleeve in its travel upwards under deflection from wheel loads applying in a vehicular application. In this way the arm vertical travel under suspension forces is limited in a way unlikely to damage the suspension components.

The structural sleeve 810 can be manufactured from metals, such as Aluminium by casting ands or machining. However, in this case it is advantageously manufactured from fibre composite materials, like the resilient arm itself. This is likely to be carbon fibre reinforced resin (CFRP), since stiffness, mass and fatigue life are paramount. Like the Smart Arm itself structural sleeve design shown lends itself to Resin Transfer Moulding of ±45° braided carbon fibre performs, with substantial amounts of 0° (uni-axial) fibre tow inlay aligned to the long axis of the part. The resulting part is a truncated closed end box section, with partially open sidewalls. With substantial material in the area of the bearing location bosses, this component will be extremely stiff, particularly in CFRP.

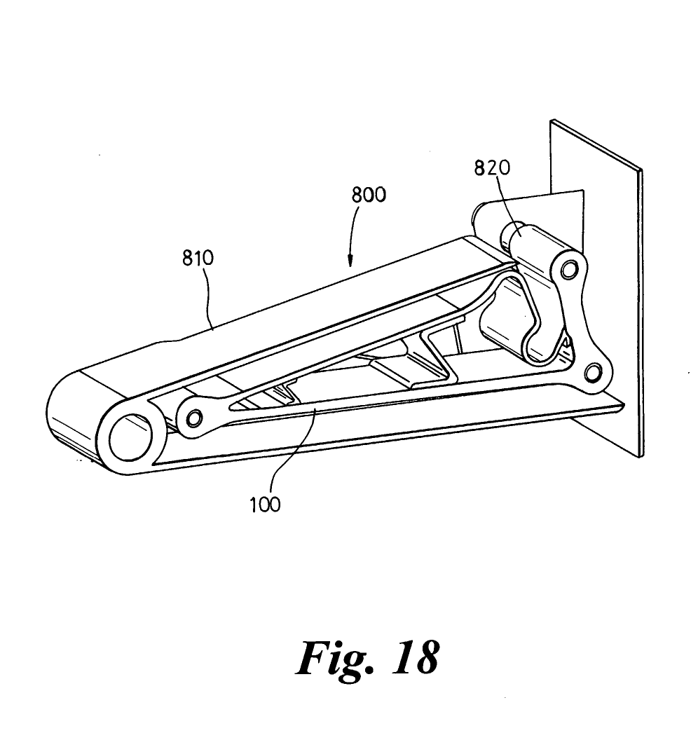

To couple the axle end of the resilient arm 100 to the sleeve 810, in order to employ its controlled deflection behaviour as a spring, within the sleeve, as a compound assembly, a single bolt is passed through the axle end boss and through matching holes in the sleeve. Thus when the sleeve rotates under vehicle loads, the deflection is coupled to the resilient arm member, which provides the spring (and damping) required. A tough elastomer type (e.g. Polyurethane) compliant bush is interposed between the shank of the bolt and the arm such that small differences are accommodated between in the locus of the hole in the sleeve under suspension deflection and the axle end boss in the resilient arm. The location of the sleeve hole and design of the sleeve and hole are adjusted to minimise these locus differences. This is shown in the section view in FIG. 18 of the accompanying drawings.

Alternatively, where the locus is not sufficiently co-incident, the resilient Smart Arm axle end bush is coupled by insertion in a slot cavity within the sleeve at this point, such that the arm is coupled mechanically to the sleeve. Similarly an elastomer insert accepts any relative movement and resulting small axial loads resulting as the unit is loaded. In this way the arm is coupled directly in bending to the sleeve.

The axle for wheel attachment is mounted in the large diameter hole at the free end of the structural sleeve in the previous manner described for the Smart Arm itself.

By this approach, the inherent torsion induced self-cambering of the wheel observed with the original Smart Arm monolithic design is mitigated, at the expense of more weight, complexity, volume, and cost. However it allows applications where self-cambering is not acceptable, even though such behaviour is potentially useful in vehicle applications.

Clearly there is much greater flexibility to accommodate more complex axle/wheel/ancillary attachment geometries to the axle end of the structural sleeve, as the load path to it is no longer part of the complex flexural spring element which parallels it in the Smart Arm itself.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1-28. (canceled)

29. An apparatus for connecting a load to a support which comprises a flexible suspension arm of unitary construction, said suspension arm defining at least two spaced apart members, a space defined by a relative location of said spaced apart members, said space having a volume, a restoring means contained without said space, deflection of said flexible suspension arm in use causing said arm to deform to alter a relative position of said two spaced apart members, thereby altering said volume of said space and so compressing said restoring means.

30. Apparatus according to claim 29 wherein said restoring means comprises a medium comprising at least one of a gas, a collapsible solid and a foam which is contained within said space and which is compressed as said volume of said space decreases.

31. Apparatus according to claim 30 which is so constructed and arranged that said restoring means has a significant effect on a spring rate of said assembly.

32. Apparatus according to claim 29 wherein said flexible arm comprises a cantilever arm having a first fixing region generally arranged to be secured to one of a load and a support and a second fixing region generally arranged to be secured to the other of said load and said support, said arm further including a first arm member which extends from said first fixing region to said second fixing region, a second arm member which also extends from said first fixing region towards said second fixing region, and a connecting member which connects said second arm member to said first fixing region of said arm, said connecting member defining said two spaced apart members which comprise wall portions which define parts of a wall defining a closed volume for said damping medium.

33. Apparatus according to claim 32 wherein said unitary member generally defines a quarter elliptic type spring.

34. Apparatus according to claim 32 wherein said first arm member provides a major spring member which forms a major path for loads from said second region to said first region and said second arm member functions predominantly as a minor spring member.

35. Apparatus according to claim 32 wherein said first arm member and said second arm member are elongate, planar members, said first arm member terminating at a root which is adapted to be secured to one of a load and a support, and said connecting member being provided between said root and said second arm member.

36. Apparatus according to claim 32 wherein said connecting member is generally C-shaped with one end of said C connected to said second arm member and another to said first arm member, application of a load to deform said unitary structure pushing said ends of said C shape together to reduce a volume said C shape encompasses.

37. Apparatus according to claim 29 wherein said restoring means comprises a medium contained within a bladder which is located in said closed space between said two spaced apart members of said arm.

38. Apparatus according to claim 29 wherein a closure member is provided which co-operates with said spaced apart members of said connecting member to substantially completely close off said space between said spaced apart members, thereby defining a controlled volume whose volume changes as said arm is deflected under load.

39. Apparatus according to claim 38 wherein said restoring means includes a valve for controlled addition of medium from said control space.

40. Apparatus according to claim 39 which also includes a controller for controlling a pressure of said restoring means in said control space, said controller receiving signals from at least one sensor which measures deflection of at least one part of said suspension arm.

41. Apparatus according to claim 29 wherein said arm comprises a fibre reinforced composite (FRC) laminated structure.

42. Apparatus according to claim 29 wherein said unitary component has a constant cross section across at least one axis.

43. Apparatus according to claim 29 wherein said arm includes at least one interconnecting strut of a z-shaped cross section when said arm is unloaded.

44. Apparatus according to claim 29 wherein a reinforcing sleeve is provided around at least part of said arm which is connected to said arm at opposite ends in such a way as to restrain twisting of said arm whilst permitting at least some longitudinal movement between said arm and said sleeve at least at one point of connection.

45. A suspension system which includes at least one support apparatus according to claim 29.

46. A suspension assembly for a vehicle which comprises a fibre reinforced composite arm which defines a space which contains a restoring means, said member being so constructed and arranged that, in use, as said arm bends under loading a volume of said space varies which compresses said restoring means.

47. A suspension assembly according to claim 46 which includes at least two support arms connecting a load to a support arranged such that they are operated in tandem.

48. A suspension assembly according to claim 47 wherein two arms are provided which are attached above and below a load connecting point respectively.

49. A suspension assembly according to claim 48 wherein said pressure restoring means in said space of each arm can be varied to alter the relative position of said load connecting point relative to said support at rest as well as to alter the spring rate of the arrangement.

50. A suspension assembly according to claim 47 wherein two arms are provided in a series arrangement such that said arms are aligned side by side with a load acting through an axis common to both arms.

51. A suspension assembly according to claim 45 which further includes a control means arranged to alter the spring rate of said suspension assembly to control a ride height of said vehicle.

52. A suspension system for a two wheel vehicle comprising first and second suspension assemblies having adjustable spring rates, each provided on an opposing side of a wheel from said other to support a wheel relative to a frame of said vehicle and permit deflection of said wheel relative to said frame, said system being arranged such that in use the spring rate of each assembly is varied under control of at least one control unit to alter the camber of said wheel relative to said chassis.

53. A suspension system for a two wheel vehicle according to claim 52 wherein said supports comprise suspension arms in accordance with claim 29.

54. A suspension system for a two wheel vehicle according to claim 52 wherein said control unit is adapted to vary the spring rates of each suspension assembly in response to signals collected from sensors fixed to said vehicle.

55. A suspension system for a two wheel vehicle according to claim 52 wherein said control unit is arranged to alter the spring rates to compensate for at least one of understeer and oversteer of said vehicle by applying rear-wheel steer (through camber changes) to alter a radius of turn of said vehicle.

56. A suspension system for a two wheel vehicle according to claim 52 wherein said control system is adapted to determine an intended radius of turn of a rider and compare it to an actual radius defined from sensor outputs, and from said difference determine the spring rates to be applied to each suspension assembly to alter said radius of turn of said vehicle.
